(19) United States
(12) Patent Application Publication
(10) Pub. No.: US 2006/0251843 A1
(43) Pub. Date: Nov. 9, 2006

(54) Temporary camouflage tattoo

(76) Inventors: James K. Givens, El Cajon, CA (US); Mark H. Dice, El Cajon, CA (US)

Correspondence Address: David B. Waller, Suite 214, 5677 Oberlin Drive, San Diego, CA, 92121, US

(21) Appl. No.: 11/348,656

(22) Filed: Feb. 3, 2006

Related U.S. Application Data
(63) Continuation-in-part of application No. 11/123,636, filed on May 6, 2005.

(51) Int. Cl. B32B 33/00

(52) U.S. Cl. 428/40.1

(57) ABSTRACT

The present invention provide compositions and methods for preparing and applying moisture activated removable camouflage tattoos for disguising exposed skin or inanimate surface. The tattoo carrier sheet comprises a water permeable transfer sheet, at least one temporary and removable moisture activated facial camouflage tattoo disposed on the water permeable transfer sheet. A protective release sheet is removably disposed on the water permeable transfer sheet over the facial camouflage tattoo as temporary protective covering for the facial camouflage tattoo. The method of application comprises removing the protective release sheet, exposing the water permeable transfer sheet to water, contacting the camouflage tattoo with a surface, and removing the water saturated water permeable transfer sheet thereby depositing the camouflage tattoo on the surface.

### CROSS-REFERENCE TO RELATED APPLICATIONS

This application is a continuation-in-part of patent application Ser. No. 11/123,636 filed May 6, 2005.

### FIELD OF INVENTION

This invention relates to a removable or soluble tattoo for transferring a camouflage pattern onto a person's face or exposed areas as well as onto inanimate surfaces. In a particularly preferred application, tattoos are provided for use in camouflaging military personnel and military, hunting, research and/or gaming equipment.

### BACKGROUND OF THE INVENTION

For years people have applied masks, paints and more recently cosmetic formulations to their faces to mask or disguise their appearance. This has been done in traditional dances or ceremonies, in the theater or on stage, in the military or for hunting and on holidays such as Halloween. While masks may be worn for a number of occasions such as parties, trick or treating and on stage they are generally not recommended for use in military operations or hunting. For a number of reasons masks, with the exception of ski masks, are not used for these activities because they are often times uncomfortable, can obstruct viewing and can be easily displaced during use.

Face paints such as those currently used by military personnel are generally oil based to prevent being compromised by rain or by submersion in water. Because of this these paints are difficult to remove and cumbersome to apply. Cosmetic formulations and make-up are removable with soap and water but can be time consuming to apply in a particular pattern on design.

Consequently, there is a need for a composition that can be applied to a users face to disguise or camouflage their appearance that is able to withstand submersion in water and rain, that can be easily removed with soap and water and is easy to apply.

In addition when hunting, conducting military operations, playing games such as paintball of air soft or conducting wildlife research and the like, participants often conceal their presence by wearing clothing of a particular pattern that allows the person to blend with the surroundings. Camouflaging equipment such as vehicles, armament, weaponry, research equipment and other items that might be used in the field is also well known for military personnel and civilians. Such items include for example, clothing, jackets, hats, helmets, boots, gloves, flashlight housings, guns, knife sheaths and handles, cameras and scopes. Clothing and textiles are prepared with camouflage patterns and hard surfaces are generally painted with colors that disguise their appearance from easy recognition. Unfortunately, there are a variety of terrains that an individual may enter in combat, while hunting, conducting research or playing games. Consequently, for a surface to provide the correct camouflage to blend with the current terrain the soldier, hunter, researcher or player must have a number of similar weapons, equipment and gear that match each possible terrain. This is expensive and for the military could be logistically problematic.

Therefore there is a need for camouflaging methods that would allow the hunter, soldier, researcher or player to modify his/her gun and/or equipment quickly and easily in the field to substantially increase their chances of remaining undetected.

### SUMMARY OF THE INVENTION

In accordance with the present invention a moisture activated removable camouflage tattoo carrier sheet is provided for disguising an inanimate, or animate surface. If the surface is an inanimate object the moisture activated removable camouflage tattoo may be applied to surfaces including those located on vehicles, artillery and weaponry. If the surface is an animate object, it is preferably a surface of a human such as for example a face or hands. If the surface is a face the pattern could be a representation of an actual animal or human face or a representation of a fictional animal, human or cartoon character face. If the pattern is a human face, it could be any number of patterns such as for example a clown face or a geisha dancers face. If the pattern is a fictional human face, it could be any number of patterns such as for example a Frankenstein face or a skull. If it were a fictional animal face, it could any number of patterns such as for example a werewolf face.

In one aspect of the present invention the moisture activated removable camouflage tattoo carrier sheet comprises a water permeable transfer sheet, at least one temporary and removable moisture activated facial camouflage tattoo disposed on the water permeable transfer sheet, and a protective release sheet removably disposed on the water permeable transfer sheet over the facial camouflage tattoo as a temporary covering and to protect the facial camouflage tattoo.

In another aspect of the present invention, the moisture activated camouflage tattoo carrier sheet comprises a water permeable transfer sheet, at least one removable moisture activated camouflage tattoo disposed on the water permeable carrier sheet and a protective release sheet removably disposed on the water permeable transfer sheet over the camouflage tattoo for a temporary protective covering.

In yet another aspect of the present invention, a method for disguising a surface is provided by applying a moisture activated camouflage tattoo to a surface. The camouflage tattoo comprises a water permeable transfer sheet, at least one removable moisture activated camouflage tattoo disposed on the water permeable carrier sheet and a protective release sheet removably disposed on the water permeable transfer sheet over the camouflage tattoo as a temporary protective covering. The method comprises removing the protective release sheet; exposing the water permeable transfer sheet to water; contacting the camouflage tattoo with a surface; and removing the water saturated water permeable transfer sheet thereby depositing the tattoo on the surface.

In one embodiment of either aspect of the present invention, the moisture activated removable camouflage tattoo carrier sheet comprises water-soluble vegetable dye. In the case of a facial tattoo the dye may be hypoallergenic. The dye may be provided in a variety of patterns including a woodland pattern, a desert pattern, a tiger stripe pattern, and an urban pattern. These patterns may be digitally created or may be created by hand. When the pattern is a desert pattern, it may be for example a chocolate-chip desert pattern or a tri-color desert pattern. The carrier sheet may be provided in preformed shapes or in one continuous sheet that the user may cut into desired shapes. In the case of a facial tattoo the shapes may be preformed for application to the users face such as for example the forehead, cheeks, chin, forehead and cheeks, cheeks and chin or forehead, cheeks and chin.

In another embodiment of the present invention the moisture activated removable camouflage tattoo is transferable or applied to the skin or a variety of surfaces including those located on military, hunting, research and/or gaming equipment, vehicles, artillery and weaponry upon application of water to the water permeable transfer sheet.

### BRIEF DESCRIPTION OF THE DRAWINGS

FIG. 1 is a diagrammatic representation of (A) a digital woodland pattern, (B) a digital desert pattern, (C) a general woodland pattern, (D) a “chocolate-chip” desert pattern, (E) a tri-color desert pattern, (F) a urban pattern and (G) a tiger stripe.

FIG. 2 is a diagrammatic representation of tattoo section pieces for application of potions of a tattoo to particular areas of the face.

FIG. 3 is a diagrammatic representation of an actual animal face.

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “equipment” as used herein refers to items that may be carried onto or utilized in the field. For example military equipment may include for example a variety of vehicles that may be used in battle, preparing for battle, during an occupation, and the like artillery or weaponry used in battle or carried for battle, other items such a cameras, scopes, radios, flashlights, and the like. Hunting equipment may include for example guns, knives, bows, sling shots, cameras, radios, compass and the like. Gaming equipment may include for example projectile weapons such as paint ball guns, air soft guns, protective headgear or helmets, chest, leg, knee, arm, and/or elbow protectors and the like. Research equipment may include for example cameras, sound equipment, spotting scopes, blinds, headphones and the like.

The term “fictitious” as used herein refers to a pattern preferably for a human face that is a caricature of an actual organism whose image is transferred to a temporary tattoo of the present invention. For example, a likeness of an animal as compared to an actual photo of an animal.

The term “game” or “games” as used herein refers to is a competitive activity in which camouflage is used by the participants to reduce visual recognition by other participants. For example such games include paint ball and air soft.

The term “ink” as used herein refers to a compound that is able to provide a desired color to the desired surface. Preferable ink includes dyes, colorants, pigments and the like. Preferably the ink is derived from a vegetable dye.

The term “majority” as used herein refers to greater than 50% of the entirety, greater than 60% of the entirety, greater than 70% of the entirety, greater than 80% of the entirety and/or greater than 90% of the entirety of an object such as a gun.

The term “moisture activated” as used herein refers to a removable camouflage tattoo that is readily transferable from a moisture permeable transfer sheet that carries the tattoo onto a flexible or solid surface. This is generally performed by the application of moisture or water as delivered by a sponge, cloth or the like, to the side of the moisture permeable sheet opposite the side the tattoo is located.

The term “recreational” as used herein refers to activities conducted in the private sector as opposed to the military sector of our society. For example, the use of the tattoos of the present invention for recreational use could include deer hunting or paint ball games as opposed to military use which could include camouflaging the face of enlisted personnel for operations such as sniping enemy targets.

The term “removable” and “temporary” as used herein refers to the ability of the tattoo image to be wiped-off or removed from the surface on which it has been applied. Preferably this is performed by normal washing with conventional soaps, mineral oil or other removal compositions and the like. These terms include a wide range of effort that may be needed for removal of a given tattoo. For example, these terms include tattoos that are easily removed by soap and water with a minimal amount of scrubbing. In addition, they include tattoos that may be considered to be permanent only because of the difficulty and amount of effort required for their removal from a surface but are none the less considered in the context of this invention “removable”. If the image is provided on a decal the term “removable” or “temporary” refers to the ability of the decal to be pealed from the surface in one or more pieces.

The term “surface” as used herein refers to any inanimate surface that is acceptable to receiving a tattoo or decal. An acceptable surface is one that is able to retain and maintain in position a tattoo or decal in such a way that it essentially camouflages a majority of the surface covered by the tattoo or decal.

Removable Tattoo

The tattoos of the present invention may be provided on moisture activated transferable sheets that have the capability to transfer colorant materials directly to the skin or may be provided on flexible thin polymer slip layer, also known as a decal, that carries the image and has a contact adhesive on one side to allow the image to be affix directly to the skin. A wide variety of methods are known for the preparation of removable tattoos. One method for preparing removable eyebrow tattoos is disclosed in U.S. Pat. No. 6,161,554 and is incorporated herein in its entirety. Another method of manufacturing a temporary tattoo is by offset or silk screen conversion this method is described more fully in U.S. Pat. No. 5,958,560 and is incorporated herein in its entirety. This patent also describes methods that substantially reduced production time by utilizing advancements in laser jet printer technology. A method for preparing temporary tattoo decals is disclosed in U.S. Pat. No. 6,074,721 the contents of which are incorporate herein by reference in its entirety. The decals contemplated by the present invention when used for camouflaging purposes will have surfaces that reduce, or eliminate, the reflective qualities of the upper surface of the decal. More specifically, the flexible thin polymer slip will have a matte finish as opposed to a glossy finish so that light reflection is reduced to a minimum.

Common among all these methods is a water permeable transfer sheet. This sheet is preferably composed of a material that allows for moisture or water to pass from the backside of the sheet to the front side of the sheet in order to allow the tattoo and/or decal to be transferred and adhered to the skin. The water permeable transfer sheet is selected from materials that have a generally high rate of absorption. In one method described in the U.S. patents referenced the paper stock is 8 mil 100-lbs. stock. This heavy gauge paper adds stability when the coatings are applied. To the smooth side of the paper stock is applied a water-soluble coating in a layer approximately 0.1 mil or about 12 lbs. per ream to paper stock. They prefer a cellulose acetate base for this coating. The thickness of the coating allows the partial dissolution of the coating when exposed to water and allows it to separate from the paper stock and for the water soaked paper to be removed leaving the residue from the water soluble coating.

Adjacent to the water-soluble coating is a UV inhibitive layer that prevents UV energy from the sun or other sources from bleaching the ink of the tattoo. One composition that may be utilized is suntan lotion having a sun protection factor (SPF) of approximately 35. A thin and consistent layer of this coating is applied to the water-soluble coating. The coating is not water-soluble so it is not functionally affected by the water dissolution or partial dissolution of the water-soluble coating. Adjacent to the UV inhibitive layer coating is a non-water soluble coating referred to as an adhesive deadener. This adhesive deadener prevents the water and the water-soluble coating from penetrating the ink and dissolving the colors. It further binds the inks and the remainder of the coatings to the pressure sensitive adhesive so that it does not become tacky once applied to the skin. The base for this coating is polyvinyl alcohol and is applied in a thick and consistent coating of about 0.8 mils or 12 lbs. per ream of paper.

Adjacent to the adhesive deadener is a clay based coating that aids in the ink drying and inks anchorage. The inks are then applied directly to this coating. The removable facial camouflage tattoo can comprise a ink, preferably consisting of a hypoallergenic water soluble vegetable dye or ink that is capable of being transferably moisture activated to adhere to the user's face upon application of moisture to the back of the water permeable transfer sheet. Once the ink is deposited a pressure sensitive adhesive is applied over the image created with the ink. This adhesive is generally a hypoallergenic and water-resistant acrylic copolymer. Over this layer is applied a backing material, generally a clear polymer film so that the tattoo may be viewed from the surface. Types of backing material include for example polypropylene, polyester or polyvinyl alcohol, Kraft or tag paper.

In use, the backing sheet and second release coating are removed from the temporary tattoo exposing the adhesive. This surface is then applied to the desired skin area of the face. The paper is the exposed to water or moisture. Once saturated, the paper may be removed leaving the temporary tattoo affixed to the skin.

Patterns

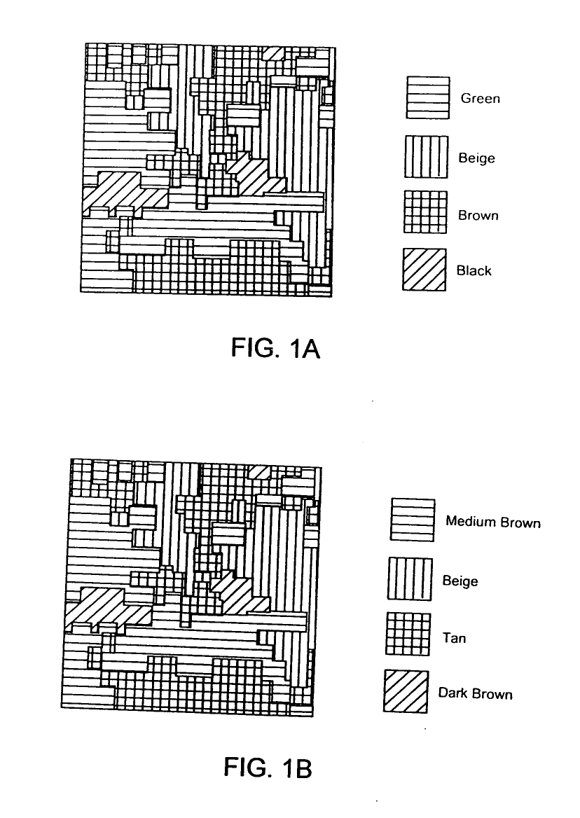

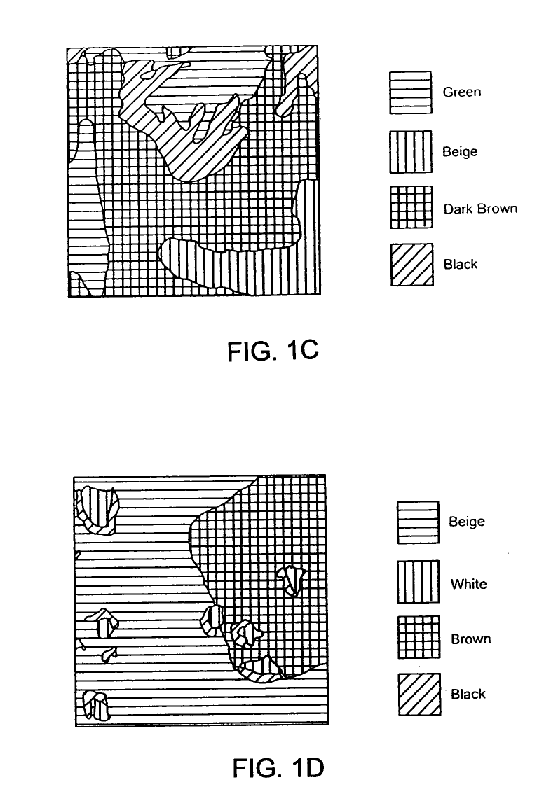

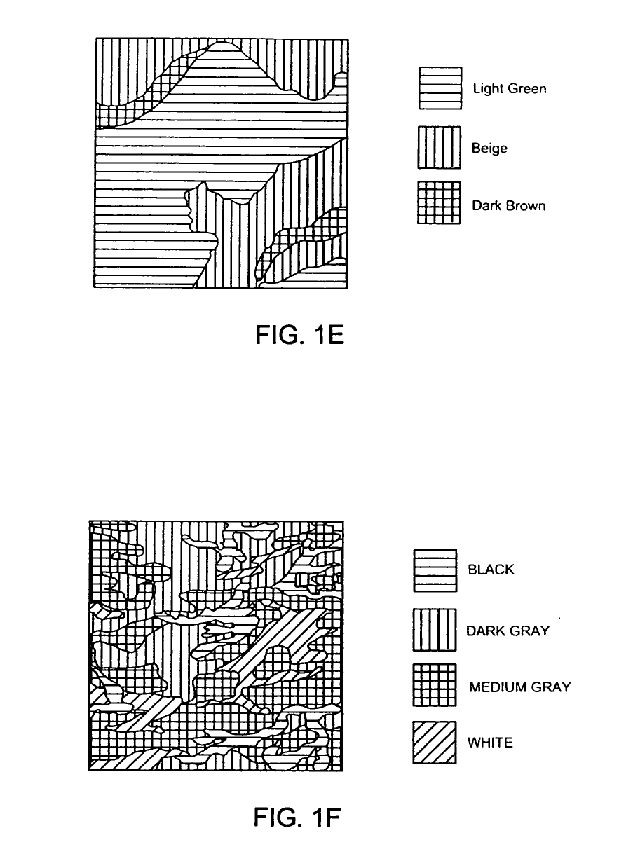

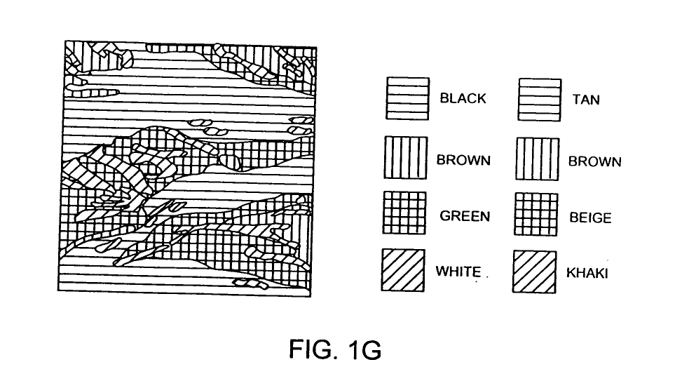

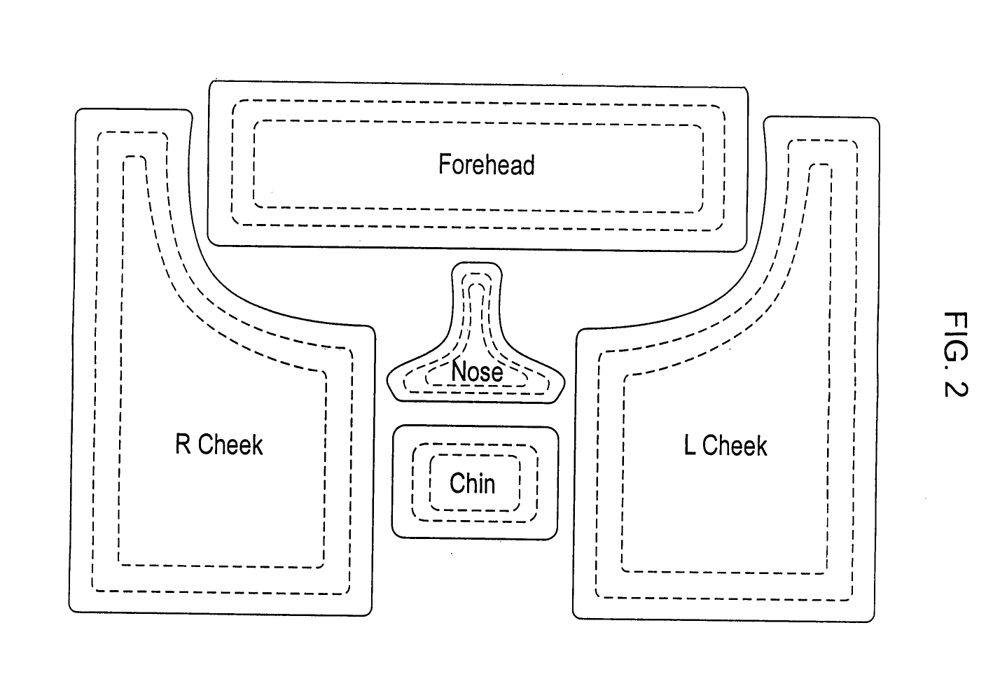

The removable tattoos of the present invention are utilized for disguising a majority of a user's face or desired surface. These patterns may be designed for military applications or for recreational activities. Military patterns may include for example a variety of images that mimic the terrain of a particular area that a soldier may encounter during operations. These include for example natural images showing realistic leaves, trees, branches, rocks, etc. or may be intermixed regions of colors typically encountered in particular types of terrain such as for example blacks and greens for forested terrain and brown and tans for desert terrain or they may be digitally created patterns of intermixed regions of colors that have been computer generated. FIG. 1 shows a number of examples of terrain tattoo patterns. Patterns such as these may be provided in large sheets that may be cut into appropriate sizes and shapes based on the size and shape of the face or surface on which they are to be applied. Correspondingly the tattoos may be provided in sections for ease of application to portions of a face or surface. In the case of a facial tattoo, sections may be provided for the forehead, cheeks, chin, forehead and cheeks and/or cheeks and chin.

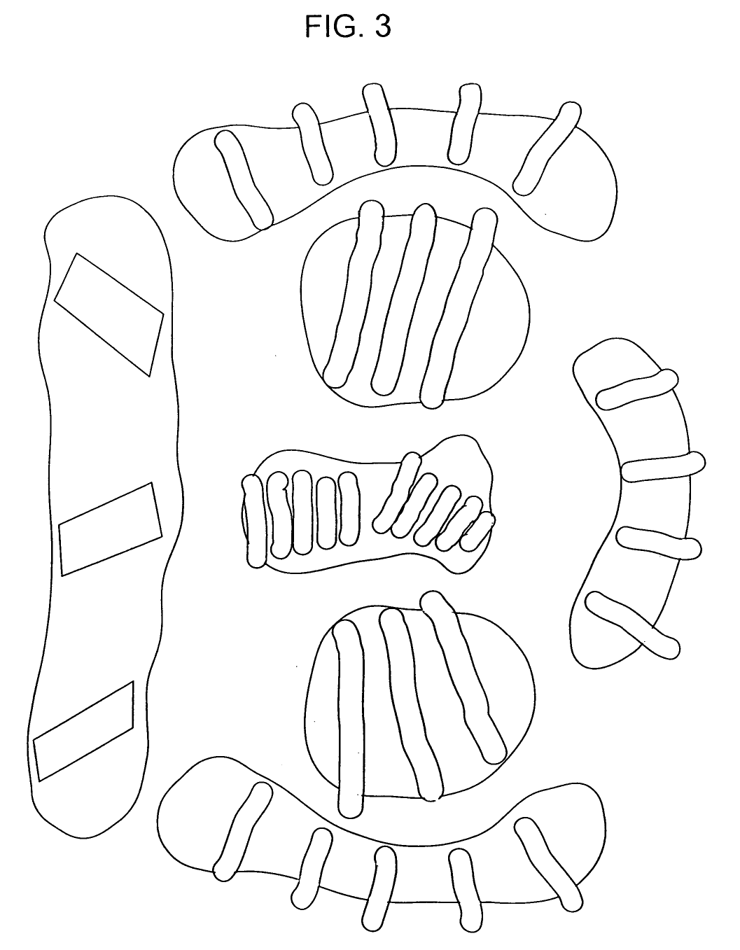

The removable tattoos of the present invention could also be patterns representing an actual animal face, a human face, a fictitious animal face, a fictitious human face or a cartoon face. For example a representation of an actual animal face could be a tiger face (see FIG. 3, solid enclosed lines indicate regions of different color) and a representation of a fictitious animal face could be a werewolf. Examples of a human face could be the make-up applied on the faces of Geisha dancers, or make-up use in the theater to make an individuals' face appear older or injured. A representation of a fictitious human face could be Frankenstein or a skull. Cartoon faces could be clown faces or characters recognized in comic strips or television cartoon personalities. Patterns such as these may be provided in single sheets for direct application to the face or may be provided in sections such as forehead, cheeks, chin, forehead and cheeks and/or cheeks and chin so that they may be more easily applied.

In addition, the tattoos of the present invention may be used on other exposed areas of the body such as for example the hands. If desired, the tattoo sheets may be precut into the shape of a hand for easy application. Alternatively, the user may cut the tattoo sheet into the appropriate size for application to the hand.

Surfaces

The methods and tattoos of the present invention may be applied to a variety of desired surfaces. These surfaces include both solid and flexible surfaces. Solid surfaces include for example, surfaces of vehicles; such as trucks, personnel carriers, boats, trains, tanks and the like; artillery such as for example cannons, rocket launchers, bazookas, and the like; weaponry such as guns, missiles, knifes and the like; and other items such as flashlight housings, radios, cameras, scopes and the like. Flexible surfaces include textiles such as items made of cloth, rubber, fiberglass, carbon fiber and the like.

In certain applications it is not necessary for the tattoo to remain intact for long periods of time and may actually be a single one-time use. In such a case the tattoo could be removed following the completion of a military operation, hunt, game or competition, or research study or project. Consequently, it would not be critical for the tattoo to maintain integrity for an extended period of time and therefore could be applied to textiles that are relatively flexible without concern over cracking or flaking.

What is claimed is:

1. A moisture activated removable facial camouflage tattoo carrier sheet for disguising a majority of a human face comprising:
a water permeable transfer sheet,
at least one temporary and removable moisture activated facial camouflage tattoo disposed on said water permeable transfer sheet: and
a protective release sheet removably disposed on said water permeable transfer sheet over said facial camouflage tattoo for a temporary covering and protecting said facial camouflage tattoo.

2. A moisture activated removable camouflage tattoo carrier sheet for disguising a majority of a surface comprising:
a water permeable transfer sheet,
at least one temporary and removable moisture activated camouflage tattoo disposed on said water permeable transfer sheet: and
a protective release sheet removably disposed on said water permeable transfer sheet over said camouflage tattoo for a temporary protective covering said camouflage tattoo.

3. A moisture activated removable camouflage tattoo carrier sheet according to claim 2 wherein the at least one temporary and removable moisture activated camouflage tattoo comprises water-soluble vegetable dye.

4. A moisture activated removable camouflage tattoo carrier sheet according to claim 2 wherein said camouflage tattoo is transferable to and temporarily adheres to a surface upon application of water to said water permeable transfer sheet.

5. A moisture activated removable camouflage tattoo carrier sheet according to claim 2 wherein said image is selected from the group consisting of a woodland pattern, a desert pattern, a tiger strip pattern, and an urban pattern.

6. A moisture activated removable camouflage tattoo carrier sheet according to claim 5 wherein said woodland pattern is a military digital woodland pattern.

7. A moisture activated removable camouflage tattoo carrier sheet according to claim 5 wherein said desert pattern is selected from the group consisting of a military digital desert pattern, a chocolate-chip desert pattern and a tri-color desert pattern.

8. A method for disguising a surface by applying a moisture activated camouflage tattoo comprising: a water permeable transfer sheet; at least one removable moisture activated facial camouflage tattoo disposed on said water permeable carrier sheet; and a protective release sheet removably disposed on said water permeable transfer sheet over said camouflage tattoo for a temporary protective covering said method comprising:
a. removing said protective release sheet;
b. exposing said water permeable transfer sheet to water;
c. contacting said camouflage tattoo with a surface; and
d. removing said water saturated water permeable transfer sheet thereby depositing said tattoo on said surface.

9. A method according to claim 8 wherein said removable moisture activated camouflage tattoo on said carrier sheet comprises water-soluble vegetable dye.

10. A method according to claim 8 wherein moisture activated removable camouflage tattoo on said carrier sheet is transferable to and removably adheres to a desired surface upon application of water to said water permeable transfer sheet.

11. A method according to claim 8 wherein said moisture activated removable camouflage tattoo is selected from the group consisting of a woodland pattern, a desert pattern, a tiger strip pattern, and an urban pattern.

12. A method according to claim 11 wherein said woodland pattern is a military digital woodland pattern

13. A method according to claim 11 wherein said desert pattern is selected from the group consisting of a military digital desert pattern, a chocolate-chip desert pattern and a tri-color desert pattern.

14. A method according to claim 8 wherein said moisture activated removable camouflage tattoo carrier sheet is precut into shapes to fit areas of a desired surface.

15. A method according to claim 8 wherein said surface is located on a vehicle.

16. A method according to claim 8 wherein said surface is located on artillery.

17. A method according to claim 8 wherein said surface is located on weaponry.

18. A method according to claim 8 wherein said surface is located on military equipment.

19. A method according to claim 8 wherein said surface is located on hunting equipment.

20. A method according to claim 8 wherein said surface is located on gaming equipment.

21. A method according to claim 1 wherein said surface is a human face.

22. A method according to claim 11 wherein said pattern for said human face is an animal face, a fictitious animal face, a fictitious human face or a cartoon face.
